(19) United States
(12) Patent Application Publication
(10) Pub. No.: US 2012/0218152 A1
(43) Pub. Date: Aug. 30, 2012

(54) Antenna Assembly

(76) Inventor: Rus Leelaratne, Sittingbourne (GB)

(21) Appl. No.: 13/400,420

(22) Filed: Feb. 20, 2012

Related U.S. Application Data
(60) Provisional application No. 61/446,091, filed on Feb. 24, 2011.

(51) Int. Cl. H01Q 9/04

(52) U.S. Cl. 343/700 MS

(57) ABSTRACT

An antenna assembly for an automobile including an antenna element having a resonance frequency which is higher than the frequency modulation (FM) range of frequencies for receiving at least one of amplitude modulation (AM), FM and satellite digital audio radio service (SDARS) radio signals. A printed circuit board including amplifier circuitry is in electrical communication with the antenna element for amplifying the radio signals received by the antenna element. A lumped element having a quality value greater than sixty is disposed on the printed circuit board for effectively increasing the bandwidth of radio signals which may be received by the antenna element. All of these components are disposed within a small and aesthetically pleasing cover, such as a shark fin-shaped cover.

### CROSS REFERENCE TO RELATED APPLICATIONS

This application claims priority to U.S. Provisional Patent Application Ser. No. 61/446,091 filed on Feb. 24, 2011, entitled “Antenna Assembly,” the entire disclosure of the application being considered part of the disclosure of this application and hereby incorporated by reference.

### BACKGROUND OF THE INVENTION

1. Field of the Invention

The present invention relates to an antenna for a vehicle. More particularly, the present invention relates to an antenna for a vehicle including an antenna element and a printed circuit board amplifier disposed within a cover.

2. Description of the Prior Art

Traditionally, radio antennas are disposed on the exterior of vehicles in plain view of both the driver and others outside of the vehicle. Many of these antennas have an elongated rod-like shape extending upwardly from the front or rear of the vehicle. However, some people find such antennas to be distracting and visually unappealing. Another type of vehicle antenna is embedded in the glass of the vehicle's rear windshield. However, this design also may have its shortcomings as it may interfere with the driver's visibility through the rear windshield or it may interfere with heating (defrosting) elements which may also be embedded within the rear windshield. Still another type of antenna assembly is a shark fin shaped antenna assembly discussed above, which may be more visually appealing than the elongated rod type of antenna assembly, but may suffer from reduced performance compared thereto and/or may be very costly to manufacture.

One known type of shark fin shaped antenna assembly for a vehicle is shown in PCT Application Publication No. WO2008/092312 (hereinafter referred to as “the '312 application”). The '312 application discloses an antenna assembly having a spring (helical type element) embedded within a cover. The dimensions of the spring are chosen to provide a resonance at a predetermined frequency within the frequency modulation (FM) band, which extends from about 88.0 to 108.0 MHz in the United States and Europe. Due to the complexity and volume required for this design, the antenna assembly of the '312 application may not be able to effectively receive amplitude modulation (AM) and/or Satellite Digital Audio Radio Service (SDARS) radio signals. The complexity of this design also may result in relatively high manufacturing costs as compared to other known antenna assemblies.

Another known type of shark fin shaped antenna assembly is shown in European Patent No. EP2040335 (hereinafter referred to as “the '335 patent”). This antenna assembly includes a printed circuit board having a trace printed thereon, and this trace functions as the antenna element. An antenna coil is directly attached to the printed circuit board and in electrical contact with the trace, i.e. the antenna coil is a part of the antenna element. Fabrication of this coil may be difficult and/or costly due to the high degree of accuracy which is required and the large size required to optimize the performance of the antenna element. Additionally, because of the size of the antenna coil, a larger housing may also be required than might otherwise be desirable.

Yet another type of shark fin shaped antenna assembly is disclosed in Chinese Patent No. CN2909556Y (hereinafter referred to as “the '556 patent”). This antenna assembly is of a dipole type design and includes an antenna element which resonates at a predetermined frequency within the FM range of frequencies. The design of the '556 patent primarily designed for receiving higher frequency signals, but this design may also be employed for receiving AM radio signals.

Each of the above-discussed antennas is focused on providing an antenna which has a resonance at a predetermined frequency within the FM frequency range, such as at 98.0 MHz. However, obtaining resonance at such frequencies requires that the antenna either be very long or appear to be very long. The antenna taught in the '312 application accomplishes this with the winding coil, thereby making the antenna appear to be longer than it actually is. The '335 patent, on the other hand, accomplishes this lengthening through the coil and through the printing of a very wide trace on a printed circuit board. Either way, additional space is typically required to achieve resonance at such a frequency. Furthermore, these complex structures may increase the weight, increase the cost and/or reduce the performance of the antenna assembly. Moreover, the complex structures of the antenna elements described above also may result in a cancellation of electromagnetic current vectors travelling opposing horizontal directions, which may further reduce the performance of the antenna assembly. Even further, such antenna assemblies are typically not suitable for receiving SDARS radio signals, and thus, if a vehicle having any of the above-discussed antenna assemblies is to receive satellite radio service, an additional antenna assembly may be required. If the satellite radio antenna assembly is placed adjacent to the FM antenna assembly, it could result in reduced performance of the satellite antenna assembly due to shadowing effects between the two antenna assemblies.

Moreover, due to the complexity of the above-discussed antenna assemblies, they may have a low return loss, which means that the signal picked up by the antenna element is not being efficiently transferred to the amplifier and then on to the radio.

There remains a continuing need for an improved antenna assembly which is small so that it can fit within an aesthetically pleasing cover; can receive AM, FM and SDARS radio signals; and can be cheaply fabricated.

### SUMMARY OF THE INVENTION

According to at least one aspect of the present invention, an antenna assembly is provided having an antenna element which resonates at a frequency which is higher than the frequency modulation (FM) range of frequencies for receiving at least one of amplitude modulation (AM), FM and satellite digital audio radio services (SDARS) radio signals. The antenna element is in electrical communication with a printed circuit board which amplifies the radio signals received by the antenna element. A lumped element having a high quality value is disposed on the printed circuit board for increasing the bandwidth of the radio signals received by the antenna element. The antenna element, printed circuit board and lumped element are all disposed within a cover, which can be shaped in an aesthetically pleasing manner, such as for example, a shark fin.

Since the lumped element is disposed on the printed circuit board, it can be smaller and more cheaply manufactured than the lumped elements of other known antenna assemblies. Further, since the antenna element resonates at such a high frequency, it does not have to be as long as other known antenna elements which resonate at comparatively lower frequencies. The antenna assembly thus may be lighter and/or smaller than other known antenna assemblies and can fit within a smaller, more aesthetically pleasing cover.

According to another aspect of the invention, the lumped element has a quality value of greater than sixty and is either a wire-type inductor or a chip-type inductor. Thus, the lumped element provides the antenna assembly with additional functionality and greatly improves the bandwidth of signals which the antenna element can receive at a minimal cost.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a perspective and elevation view of the exemplary antenna assembly mounted on the roof of a vehicle; and

FIG. 2 is a perspective and elevation view of the exemplary antenna assembly with the cover removed.

### DETAILED DESCRIPTION OF THE ENABLING EMBODIMENTS

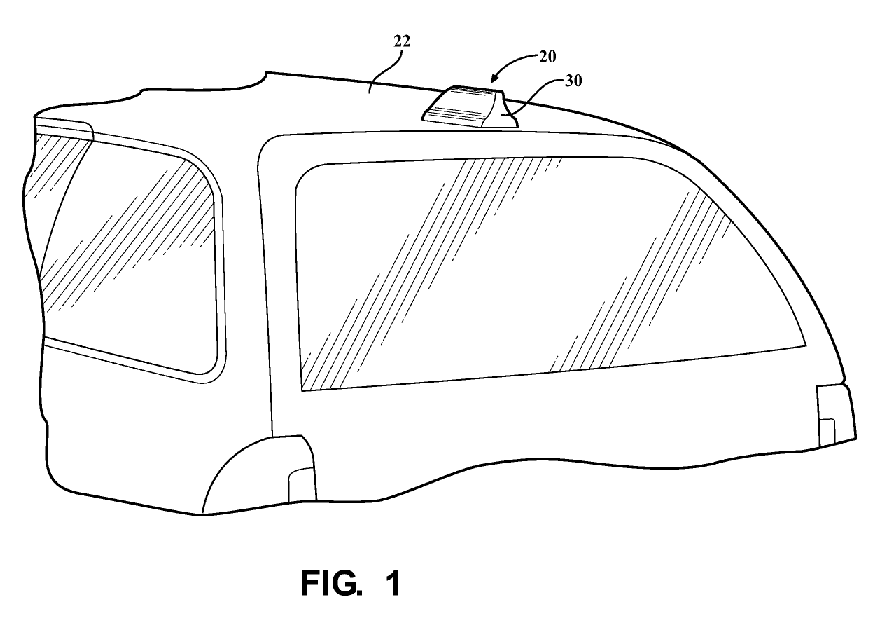

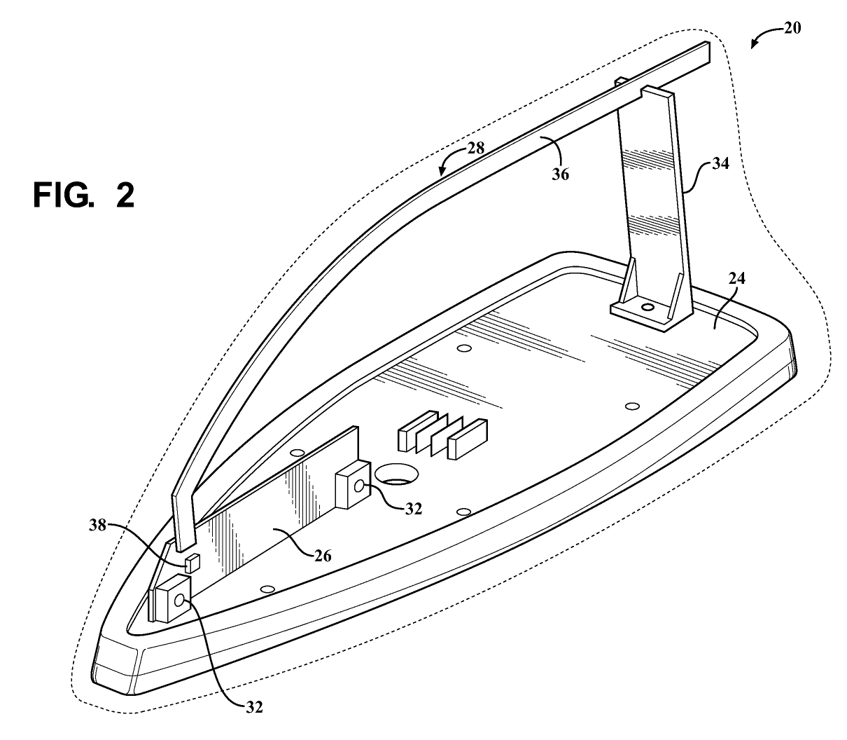

Referring to the drawings, an exemplary antenna assembly 20 constructed according to at least one aspect of the present invention is generally shown in FIGS. 1 and 2. The antenna assembly 20 is preferably for use on an automobile 22 such as a passenger vehicle, a truck, a bus, etc. However, it should be appreciated that the antenna assembly 20 could find uses in many other vehicular or non-vehicular applications.

The exemplary antenna assembly 20 includes a ground base 24, a printed circuit board 26, an antenna element 28 and a cover 30. The ground base 24 is preferably of metal and electrically grounded to a metallic component of the vehicle, such as the roof or the trunk. The ground base 24 includes at least one ground post 32 extending upwardly therefrom for receiving and supporting the printed circuit board 26 and at least one support 34 for supporting the antenna element 28. The exemplary support 34 is L-shaped with the short leg being fixed to the ground base 24 and the long leg extending upwardly to engage the antenna element 28. In addition to supporting the antenna element 28, the support 34 also prevents the antenna element 28 from rattling within the cover 30. Although the exemplary ground base 24 is of metal, it should be appreciated that the ground base 24 could be formed of any desirable material including, for example, plastics.

The antenna element 28 could take any desirable shape and may or may not cancel any electromagnetic currents. The antenna element 28 is preferably of metal and is preferably formed through a stamping or a pressing process. However, it should be appreciated that the antenna element 28 could be formed through any desirable process including, for example, extrusion or machining. The exemplary antenna element 28 a pair of opposing flat sides 36, and the flat sides 36 are oriented in a vertical plane. However, it should be appreciated that deviations in the orientation of the antenna element 28 are contemplate, i.e. the flat sides 36 could be in a horizontal plane or in a plane between the horizontal and vertical planes. However, where the flat side 36 is oriented in a plane other than the vertical plane, the performance of the antenna element 28 may be reduced. It should also be appreciated that the antenna element 28 could take many other shapes or forms, e.g. the antenna element could be a printed circuit board having an elongated trace printed thereon.

As shown in FIG. 2, the exemplary antenna element 28 has an arcuate shape which follows the profile of the exemplary cover 30 (shown in FIG. 1). However, it should be appreciated that the antenna element 28 could take any desirable shape. For example, the antenna element 28 could extend through a zig-zag shape, a fractal-type shape or any other shape or loop.

The printed circuit board 26, also known as a printed wire board, includes circuitry for amplifying amplitude modulation (AM), frequency modulation (FM) and/or satellite digital audio radio service (SDARS) signals and for conveying the amplified signals to the radio of the vehicle. Additionally, a lumped element 38, which is preferably an inductor, is disposed on the printed circuit board 26. As will be discussed in further detail below, the lumped element 38 preferably has a very high quality (Q) indicator for providing an impedance match between the antenna element 28 and the amplifier circuitry of the printed circuit board 26. Since the lumped element 38 is disposed on the printed circuit board 26 along with the amplifier circuitry, it is not a component of the antenna element 28.

In order to fit within a small, aesthetically pleasing cover 30, the antenna element 28 is very small, and therefore, it resonates at a very high frequency. In the exemplary embodiment, the antenna element 28 resonates at a frequency between 200 and 400 MHz. Thus, although the antenna element 28 may operate across a wide range of frequencies including the ranges of AM (typically between 250 and 1610 kHz), FM (typically between 88.0 and 108 MHz) and SDARS (typically between 2.31 and 2.36 GHz) radio signals, it does not resonate within any of these ranges. Due to the lack of resonance in the AM, FM and SDARS radio signals frequency range, the antenna element 28 may produce a capacitance within portions of itself or between the antenna element 28 and other components of the antenna assembly 20. The lumped element 38 described above is selected through a conjugate matching technique to have an inductance which reduces the capacitance of the antenna element 28. As such, the lumped element 38 effectively increases the bandwidth of frequencies which may be received by the antenna element 28, thereby allowing the same antenna element to be used to receive AM, FM and SDARS radio signals.

The lumped element 38 is preferably mounted on the surface of the printed circuit board 26 on the front end of the amplifier circuitry. The lumped element 38 is preferably a wire wound type inductor to achieve a high Q value. However, it should be appreciated that the inductor could alternately be a chip-type inductor.

As shown in FIG. 2, the exemplary printed circuit board 26 including the lumped element 38 is preferably oriented in a vertical plane in order to minimize the number of component which are close to the ground base 24. Additionally, this orientation allows the cover 30 to be of a sleeker, more aesthetically appealing shape, such as a shark-fin shape. However, it should be appreciated that the printed circuit board 26 could be mounted in any desirable orientation.

Obviously, many modifications and variations of the present invention are possible in light of the above teachings and may be practiced otherwise than as specifically described while within the scope of the appended claims.

What is claimed is:

1. An antenna assembly comprising:
a cover;
an antenna element having a resonance frequency that is higher than the frequency modulation range of frequencies for receiving at least one of amplitude modulation, frequency modulation and satellite digital audio radio service signals and wherein said antenna element is disposed within said cover;
a printed circuit board disposed within said cover and in electrical communication with said antenna element for said receiving radio signals from said antenna element; and
a lumped element having a high quality value disposed on said printed circuit board for increasing the bandwidth of the radio signals received by said antenna element.

2. The antenna assembly as set forth in claim 1 wherein said lumped element has a quality factor of greater than sixty.

3. The antenna assembly as set forth in claim 1 wherein said printed circuit board is oriented in a vertical plain.

4. The antenna assembly as set forth in claim 1 wherein said cover has a shark-fin shape.

5. The antenna assembly as set forth in claim 1 wherein said printed circuit board includes amplifier circuitry for amplifying said at least one of amplitude modulation, frequency modulation and satellite digital audio radio service signals.

6. The antenna assembly as set forth in claim 5 wherein said inductor is disposed electrically on the front end of said amplifier circuitry of said printed circuit board.

7. The antenna assembly as set forth in claim 1 wherein said antenna element extends through an arcuate shape and has a pair of opposing flat sides.

8. The antenna assembly as set forth in claim 7 wherein said flat sides of said antenna element are oriented in a vertical plane.

9. The antenna assembly as set forth in claim 1 wherein said antenna element has a resonance frequency of between 200 and 400 MHz.

10. The antenna assembly as set forth in claim 1 wherein said antenna element is configured to receive amplitude modulation, frequency modulation and satellite digital audio radio service signals.

11. The antenna assembly as set forth in claim 1 wherein said lumped element is a wire-type inductor.

12. The antenna assembly as set forth in claim 1 wherein said lumped element is a chip-type inductor.

13. The antenna assembly as set forth in claim 1 wherein said antenna element and said printed circuit board are mounted on a ground base.

14. The antenna assembly as set forth in claim 13 wherein said ground base includes at least one ground post extending upwardly to engage said printed circuit board.

15. The antenna assembly as set forth in claim 13 wherein said ground base includes at least one support extending upwardly to engage said antenna element.

16. The antenna assembly as set forth in claim 15 wherein said at least one support has an L-shape.
